(19) United States
(12) Patent Application Publication
(10) Pub. No.: US 2007/0210197 A1
(43) Pub. Date: Sep. 13, 2007

(54) Refiner plate

(76) Inventor: Charles T. Carpenter, Lake Oswego, OR (US)

Correspondence Address: Garth Janke;BIRDWELL & JANKE, LLP, Suite 1400, 1100 SW Sixth Avenue, Portland, OR, 97204, US

(21) Appl. No.: 11/372,639

(22) Filed: Mar. 10, 2006

(51) Int. Cl. B02C 7/12

(52) U.S. Cl. 241/298

(57) ABSTRACT

A refiner plate defines an axis of rotation that further defines variations in azimuth. The refiner plate includes an annular body portion and a plurality of azimuthally spaced-apart elongate bars projecting from the body portion. The bars have top surfaces having elevations that vary as functions of azimuth. A disc refiner further defines a direction of rotation of the refiner plate. Preferably, each top surface slopes downwardly in the direction opposite the direction of rotation, to provide for relief. Preferably in addition, each bar has a side intersecting the respective top surface that leans forwardly in the direction of rotation, to provide for attack.

### FIELD OF THE INVENTION

The present invention relates to a refiner plate, which is typically used in a type of milling machine known as an attrition mill or disc refiner.

### BACKGROUND

Different types of “engineered” wood particles are used to produce a corresponding variety of engineered wood products. In the production of highly refined wood products such as fiberboard and paper, chips or other comminuted wood or wood refuse is milled or ground to produce small “particles” or bundles of fibers. Attrition mills or “disc refiners” are commonly used for this purpose. As a class, these produce a fine defibration and fibers with a high degree of slenderness.

Two general types of disc refiners are the “single-revolving-disc” and the “double-revolving-disc.” Both types rely on relative spinning motion between two coaxially disposed discs defining a small gap between opposed, grinding faces of the discs. In the single-revolving-disc design, one of the discs is stationary, while in the double-revolving-disc design, the two discs counter-rotate.

Raw material, typically chips, is input to the disc refiner substantially along the axis of rotation of the disc(s). The material is flung radially outwardly through the gap as a result of centrifugal force imparted to the material as a result of contact with the grinding faces of the spinning disc(s).

Two such discs 2a, 2b, are shown in cross-section in FIG. 1. There is a gap “G” between grinding faces 3 of the two discs through which the material being worked travels as it is refined into particles. Due to elasticity and therefore flexure of the discs, the spacing of the gap “G” changes as a result of the forces encountered when working the material. Particularly, the presence of the material tends to spread the discs apart.

This is typically compensated for by providing a slight “face taper” on the discs, shown highly exaggerated in FIG. 1, so that the grinding faces 3 are not absolutely perpendicular to the axis of rotation L when the discs are not processing any material. The face taper is small, so that the grinding face is flat to within about 0.0025″ even when unloaded.

FIG. 2 shows an annular sector of one of the discs 2 looking down the axis of rotation L. The axis of rotation L is an axis of azimuthal symmetry of the disc. Visible on the disc 2 is the grinding face 3. With additional reference to FIG. 3 showing a cross-section of the disc, the grinding face 3 is defined by top surfaces 4a of protruding structures 4 known and referred to in the art as “bars.” The bars 4 project above an annular body portion 9 of the disc.

The top surfaces 4a of all of the bars are typically at the same elevation “h_{bar}” with respect to a reference plane “P_{REF}” (FIG. 3) that is perpendicular to the axis of rotation L. The top surfaces h_{bar} of two opposed discs provide the desired grinding action.

Referring back to FIGS. 2 and 3, raw material flows across the grinding face 3 in the directions indicated as “D_{FLOW},” i.e., radial directions r with respect to the axis L. Due to the azimuthal symmetry of the bars shown in this example, the disc 2 may equally well spin in either of the directions indicated as “D_{SPIN}.”

The bars 4 are spaced apart by depressions known and referred to in the art as “grooves” 5, the top surfaces 5a of which are at a lower elevation “h_{groove},” than the top surfaces 4a of the bars.

The grooves 5 are typically provided with a radially spaced apart series of structures known and referred to in the art as “dams” 6 that extend cross-wise across the grooves to join adjacent bars. The dams 6 have top surfaces 6a that are at an elevation “h_{dam}” that is, at least for the most part, lower in elevation than the top surfaces of the bars; however the elevation of a given dam increases with the dam's radial distance from the axis L, and the top surface 6a of the radially outermost dam is often at the same elevation as the top surfaces 4a of the connected, adjacent bars.

The bars 4, grooves 5, and dams 6 can be recognized to form a pattern that is typically repeated in some fashion over the entire grinding face, similar to a tread pattern on a shoe or a tire. An extreme variability in such patterns has been provided in the prior art as would be expected by the analogy to tires and shoes.

The top surfaces of the grooves in conjunction with the elevation of the top surfaces of the dams provide for flinging the material up onto the top surfaces of the bars where the material is ground. Because refinement results from grinding, it is generally desirable that the top surfaces of the bars that perform this grinding lie in a single plane and are as wide as possible consistent with providing the beneficial effects of the grooves and dams.

U.S. Pat. No. 5,704,559 to Fröberg et al. represents a different strategy and model than that described above, one which relies on a certain cooperation between the patterns of the two discs.

A single “bar” as described above in the context of the '559 patent has both high and low bar portions, the terms “high” and “low” being used to describe the overall elevation of the bar portions with respect to a reference plane “P_{REF}” that is perpendicular to the axis of rotation L.

Referring to FIGS. 4-6 showing two refining elements 10 and 11 according to the '559 patent, a refining element 10 has a bar 12a and an opposed refining element 11 has a bar 12b. The refining element 10 is stationary and the refining element 11 rotates.

The bar 12a includes high bar portions 13 that are disposed directly opposite corresponding low bar portions 16 of the bar 12b; and the bar 12b includes high bar portions 15 that are disposed directly opposite corresponding low bar portions 14 of the bar 12a. The bars 12a and 12b are spaced apart to provide a gap 12 through which raw material flows in the direction D_{FLOW} (FIG. 4). The refining element 11 spins in the direction D_{SPIN} (FIGS. 5-6).

The top surfaces of both the high and low bar portions, 13-16 are angled with respect to the reference plane P_{REF} (FIG. 4). Particularly, the surfaces are inclined in the direction of increasing radial distance from the axis of rotation L.

In addition, transition surfaces connecting the high and low bar portions of the same refining element are also angled from the perpendicular to the reference plane P_{REF}. This feature is particularly asserted to “knead” more softly the material being worked, here referred to as “pulp,” as well as force the pulp to move between the two discs. It is further asserted that this working of the pulp is rendered even more effective due to the inclined top surfaces of the bar portions. It is asserted more generally that the configuration effectively disperses impurities without reducing the “freeness” of the pulp and improves the strength of the pulp.

Further, the high bar portions 15 on the rotating element 11 have a greater length, in the direction D_{FLOW}, than the high bar portions 13 on the stationary element 10, and this is asserted to provide a “pump effect” which increases throughput (capacity).

Whether or not an improvement in pulp strength, impurity distribution or throughput can be realized from the configuration of the '559 patent, it is a disadvantage that opposed bars of the respective refiner elements must be closely toleranced to align with each other. It is also an inherent disadvantage of “kneading” the pulp as taught in the '559 patent that this action breaks down the fibers and requires that a large amount of power be provided to the rotating element. Accordingly, there is a need for a refiner plate that provides for further improvements over the prior art.

### SUMMARY

A refiner plate defines an axis of rotation that further defines variations in azimuth. The refiner plate includes an annular body portion and a plurality of azimuthally spaced-apart elongate bars projecting from the body portion. The bars have top surfaces, each top surface having an elevation that varies, with respect to a reference plane perpendicular to the axis of rotation, as a function of azimuth.

A disc refiner further defines a direction of rotation of the refiner plate. Preferably, each top surface slopes downwardly in the direction opposite the direction of rotation, to provide for relief. Preferably in addition, each bar has a side intersecting the respective top surface that leans forwardly in the direction of rotation, to provide for attack.

It is to be understood that this summary is provided as a means of generally determining what follows in the drawings and detailed description and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

FIG. 1 is a cross-sectional view of a pair of opposed refiner plates in a typical disc refiner.

FIG. 2 is a plan view of a broken sector of a typical prior art a refiner plate.

FIG. 3 is a cross-sectional view of the sector of FIG. 2, taken along a line 3-3 thereof.

FIG. 4 is a cross-sectional view of a pair of opposed refining elements according to U.S. Pat. No. 5,704,559.

FIG. 5 is a plan view of a broken sector of one of the refining elements of FIG. 4.

FIG. 6 is a plan view of a broken sector of the other refining element of FIG. 4.

FIG. 7 is a pictorial view of a pair of refiner plates according to the present invention, with a sector of one of the refiner plates broken to reveal a cutting face.

FIG. 8 is a plan view of the broken sector of FIG. 7.

FIG. 9 is a pictorial view of the broken sector of FIG. 8.

FIG. 10 is a cross-sectional view of the sector of FIG. 8, taken along a line 10-10 thereof.

FIG. 11 is a cross-sectional view like that of FIG. 10 showing two sectors in cooperation.

FIG. 12 is a cross-sectional view of a sector like that shown in FIG. 10 having a jointed top surface according to a first alternative embodiment.

FIG. 13 is a cross-sectional view of a sector like that shown in FIG. 10 having a jointed top surface according to a second alternative embodiment.

FIG. 14 is a side elevation of a generic combination of refiner plates providing for relief according to the invention.

FIG. 15 is a side elevation of another combination of refiner plates providing for relief according to the invention.

FIG. 16 is a plan view of a broken sector of one of the refiner plates of FIG. 15 showing a relief in schematic form.

FIG. 17 is a side elevation of still another combination of refiner plates providing for relief according to the invention.

FIG. 18 is a plan view of a broken sector of one of the refiner plates of FIG. 17 showing a relief in schematic form.

FIG. 19 is a side elevation of yet another combination of refiner plates providing for relief according to the invention.

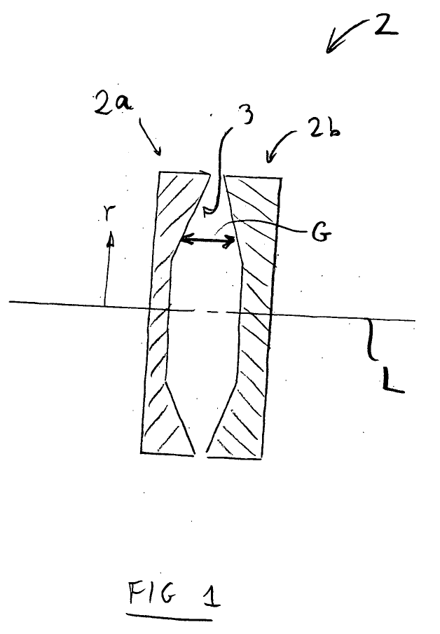

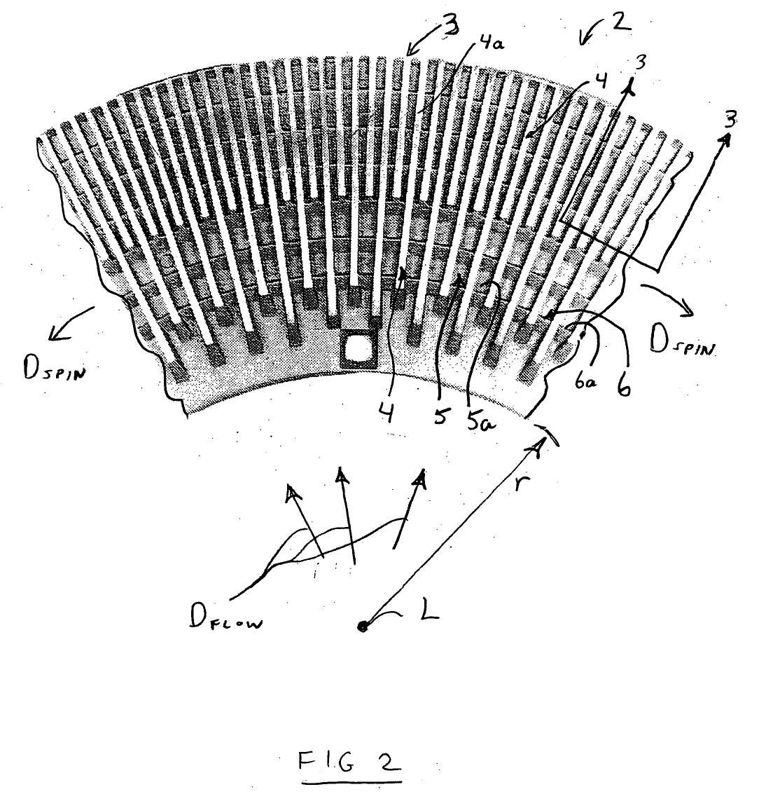

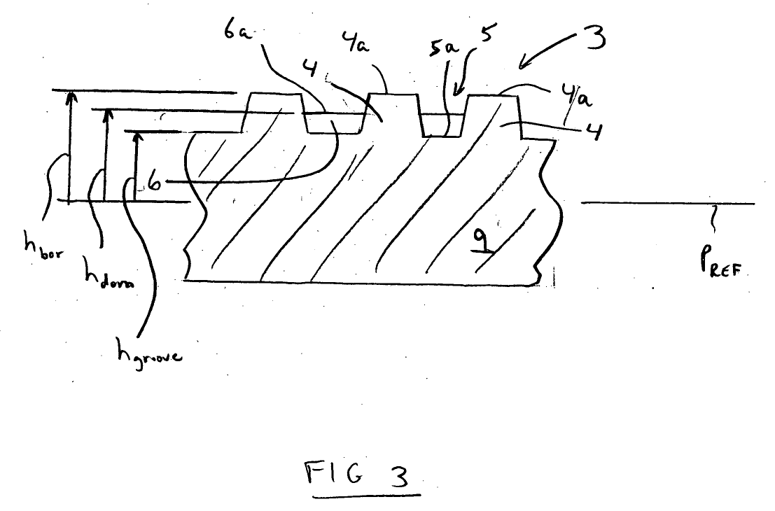

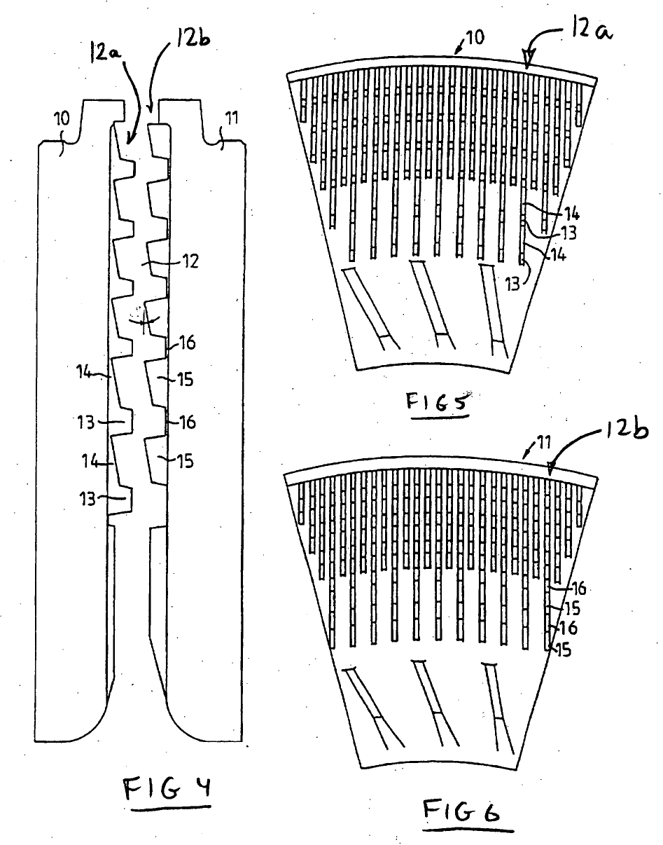

### DETAILED DESCRIPTION OF PREFERRED EMBODIMENTS

Reference will now be made in detail to specific preferred embodiments of the invention, examples of which are illustrated in the accompanying drawings.

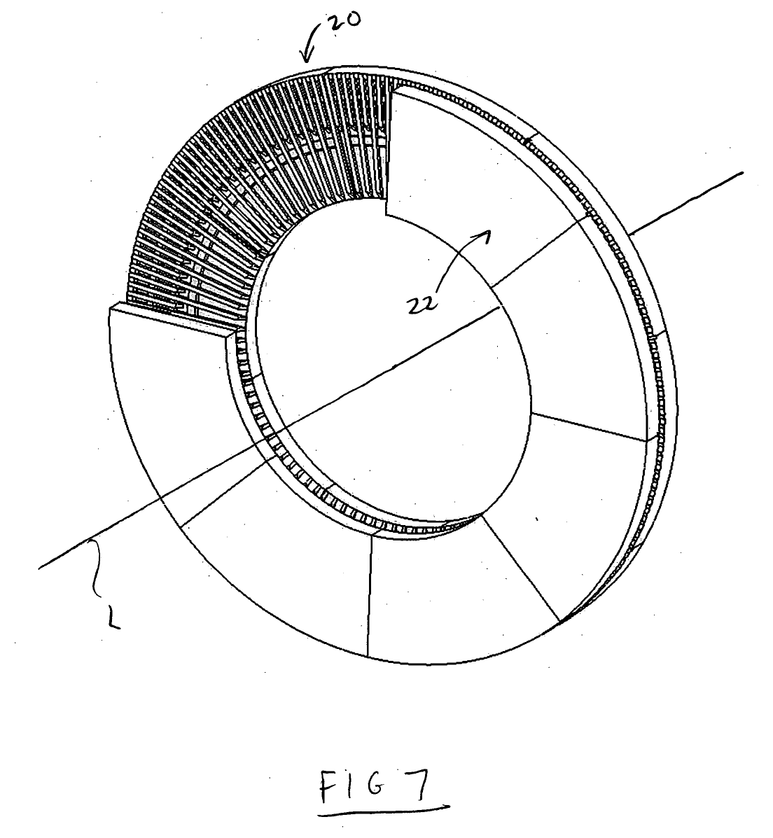

Referring to FIG. 7, a pair of refiner plates 20 and 22 are shown in opposition, as they would be confronting one another in an attrition mill (not shown).

Relative spinning of the discs about an axis of rotation “L” is provided as known in the art. That is, either one of the discs can be made to spin while the other disc is held stationary, or both of the discs can be made to spin in counter-rotation.

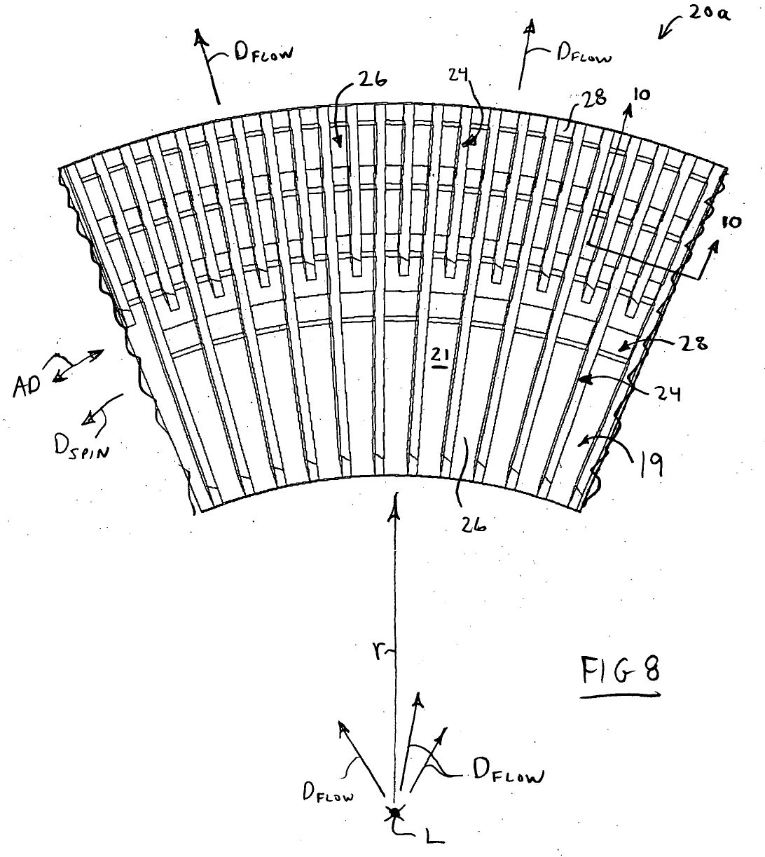

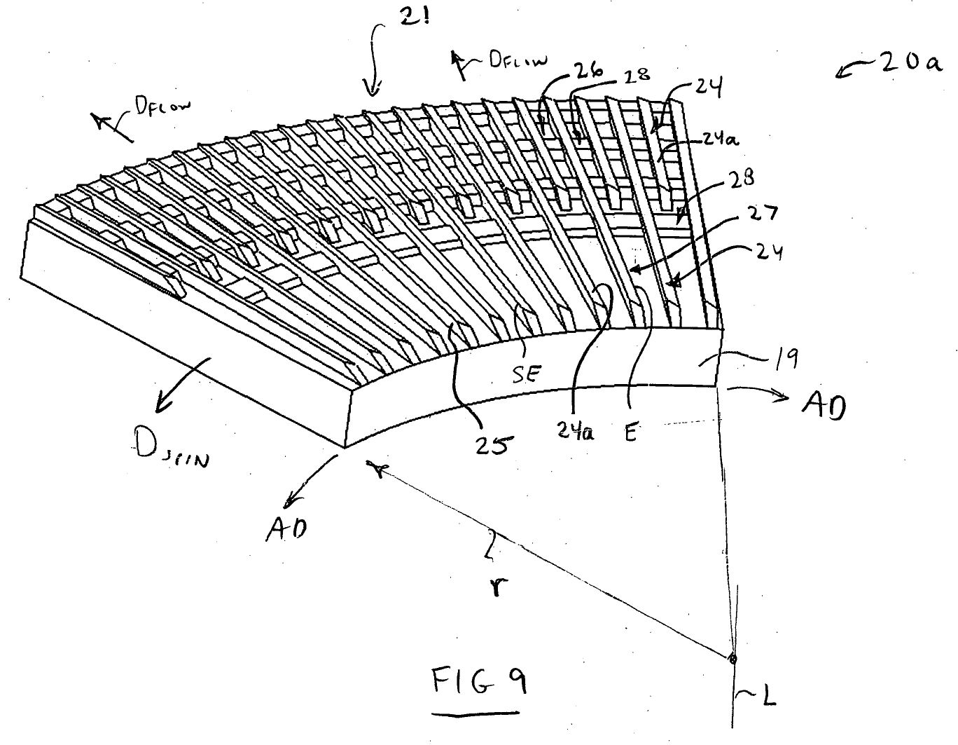

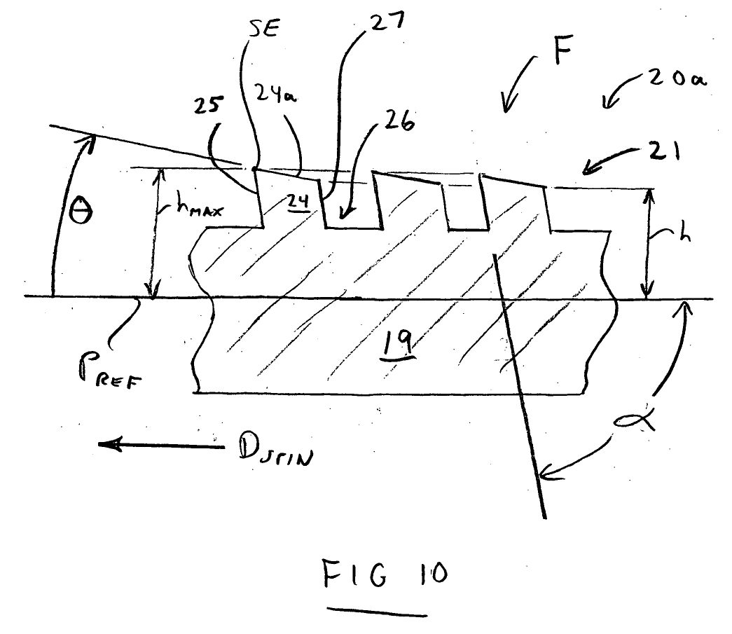

A sector of the refining plate 22 is shown broken out in FIG. 7. The removal of this sector reveals a corresponding sector of the plate 20 that is shown in plan, i.e., looking down the axis of rotation L, in FIGS. 8 and 9 where it is referenced as 20a. A face 21 of the sector 20a is seen in plan in FIG. 8 and faces upwardly in FIG. 9. The face 21 exhibits an exemplary pattern of elongate bars 24, corresponding grooves 26, and dams 28. It should be understood that the pattern shown, while being preferred, is not essential to the invention, and that the shape of the grooves and the presence of the dams, while preferably being provided substantially as shown, are also not essential to the invention.

Moreover, while the bars 24 are essentially linear as viewed in FIG. 8, bars can have other configurations, particularly curved configurations, as can grooves and dams.

The sector 20a as shown spins in the direction “D_{SPIN}.” Material to be refined flows radially over the face 21 from the axis of rotation L in directions “D_{FLOW}.” It should be understood that this material may be any material, but it is typically and preferably wood, and more particularly and preferably, wood chips.

The direction D_{SPIN} lies along an azimuthal direction “AD,” and the direction D_{FLOW} lies along a perpendicular, radial direction “r.” Both the azimuthal and radial directions are therefore defined with respect to the axis of rotation L, an azimuthal direction being a direction of constant radius, and a radial direction being a direction of constant azimuth.

While the elongate bars 24 as shown in FIG. 8 are oriented precisely along radial lines r, they may deviate somewhat from such lines, and they will necessarily so deviate if they are curved. In any case, bars are oriented generally in radial directions, meaning that they extend in radial directions at least more so than they extend in azimuthal directions.

FIG. 10 shows the cross-section indicated in FIG. 8. The bars 24 project above an annular body portion 19 of the refiner plate. Space between the bars 24 defines grooves 26. Preferably, adjacent bars viewed in radial cross-sections taken at the same radial distance have the same profile, such as shown.

A reference plane “P_{REF}” is shown that lies in the plane of FIG. 8 and is perpendicular to the axis of rotation L (see FIG. 7). This reference plane is used to reference elevation. It is to be understood that elevation can vary in radial directions and that there will in general be a lack of perfect perpendicularity of the reference plane and the perpendicular to the axis of rotation, as a result of the face taper discussed above, and that this variation can be ignored for all practical purposes herein.

The refiner plates 20 and 22 are preferably annular according to standard practice, but would not need to be to function. In any case, the axis of rotation L is an axis of symmetry of the refiner plates.

According to the invention, it is desired to provide for increased cutting action, decreased grinding action, or both, as compared to prior art disc refiners and refiner plates. To the extent the material to be refined is cut rather than ground, the resulting particles will be exposed to a minimum of damage and therefore have superior mechanical characteristics such as strength. At the same time, the power required to produce particles is dramatically reduced, providing important practical cost savings.

Continuing with reference to FIG. 10 and as also seen in FIG. 9, in accord with this intention the bars 24 have top surfaces 24a that are angled with respect to the reference plane by a relief angle θ, sloping downwardly away from the direction of rotation D_{SPIN} and therefore varying as a function of azimuth. More particularly, in this example, the top surfaces 24a are planar; they have a maximum elevation “h_{MAX}” at a leading or “upstream” side 25 of the bar that faces in the direction of spin D_{SPIN}; and a minimum elevation h_{MIN} at a trailing or “downstream” side 27 of the bar, the elevation decreasing in proportion to the relief angle θ. The relief angle θ is positive in the direction shown in FIG. 10, indicating the direction of slope.

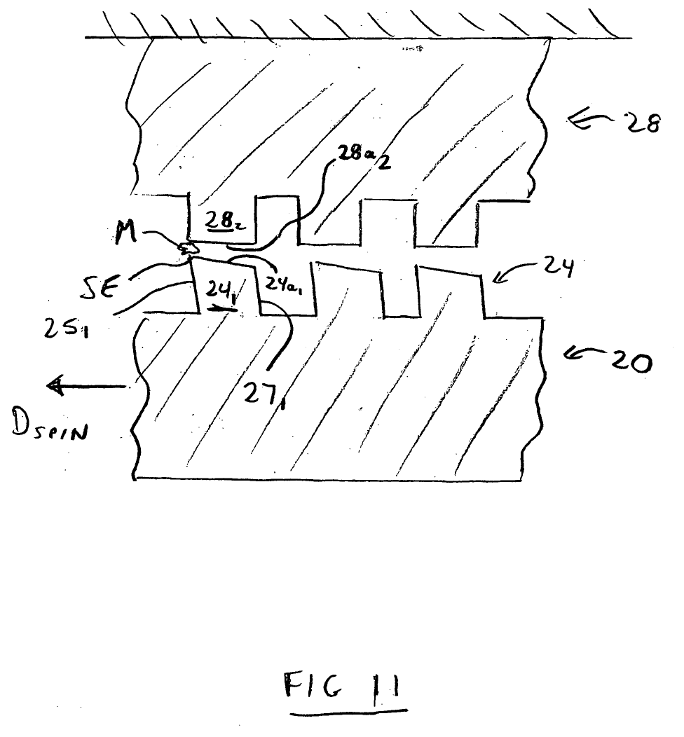

FIG. 11 shows a cross-section like that of FIG. 10 of the bars corresponding to the disc 20 and an opposed disc 28, showing a manner of cooperation between two discs. The opposed disc 28 may have bars with top surfaces that are parallel to the reference plane P_{REF}, i.e., a zero relief angle θ, as in the prior art.

The disc 28 is assumed to be stationary. An instance of material “M” to be refined is shown that is also, for simplicity, assumed to be stationary. Because the disc 20 spins in the direction D_{SPIN}, the bar 24, will first impact the material M at a sharp cutting edge “SE” (referenced also in FIG. 9) defined by the intersection of the top surface 24a₁ of the bar 24₁ and the leading side 25₁ of the bar. This edge will be made sharper as the relief angle θ (FIG. 10) is increased and the attack angle α is decreased.

The sharp edge SE will tend to cut the material M into smaller pieces. As these pieces are transmitted toward the trailing side 27₁ of the bar, the greater spacing between the top surface 24a₁ and the top surface 28a₂ of the opposing bar 28₂ of the disc 28 reduces the amount of grinding that would otherwise occur. In effect, to a substantial extent, grinding has been replaced with cutting.

In that regard, the top surfaces 24a define a face “F” of the refiner plate that corresponds to the “grinding face” described above in connection with the prior art. The term “grinding face” will be used herein to describe the face “F” and the like herein according to the present invention for consistency with prior art usage and definition of terms, but it should be understood that grinding action provided by the face “F” can be greatly reduced, or essentially eliminated according to the invention and to this extent the term is a misnomer.

The relief angle is preferably in the range 1<θ<30 degrees measured with respect to the reference plane, is more preferably in the range 2<θ<10 degrees, and is most preferably 6 +/−1 degrees, or about 6 degrees.

A non-zero relief angle both increases cutting action and decreases grinding action, the more so with increased relief angle θ. However, there is a limit to the amount of relief that is desirable for two reasons. First, the strength of the cutting edge SE is reduced with greater relief. Second, the top surface if sloped too much allows the material M to fall from the trailing side 27 to a lower elevation where it is not well positioned to be cut by the cutting edge SE of the next bar.

Returning to FIG. 10, the leading side 25 of the bars is also preferably angled from the perpendicular to the reference plane, leaning forwardly into the direction of rotation, to define an attack angle α. The attack angle α is preferably in the range 45<α<90 degrees measured with respect to the reference plane, and is most preferably in the range 85+0/−10 degrees.

The attack angle provides for attack as known in the art, though it should be noted that a smaller attack angle provides for a greater amount of attack. Greater attack contributes to increasing cutting action, by further sharpening the cutting edge SE.

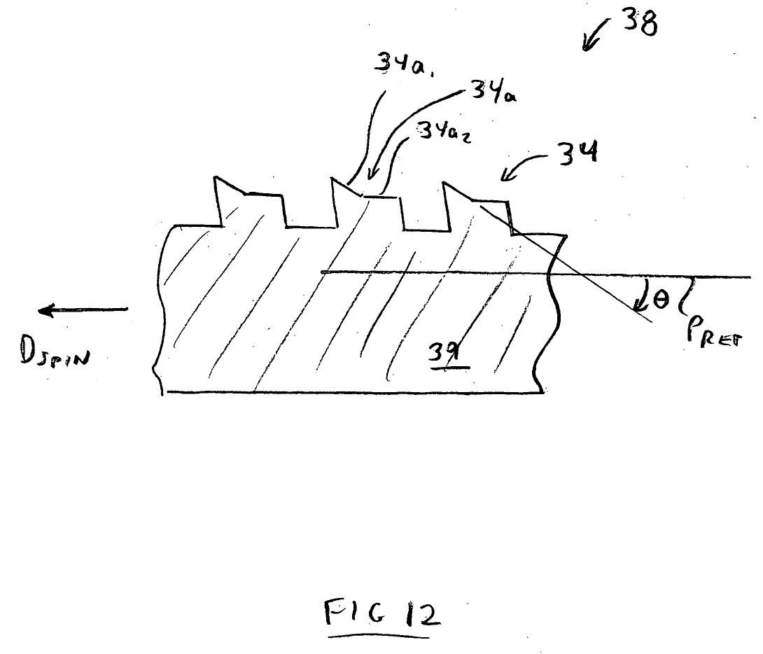

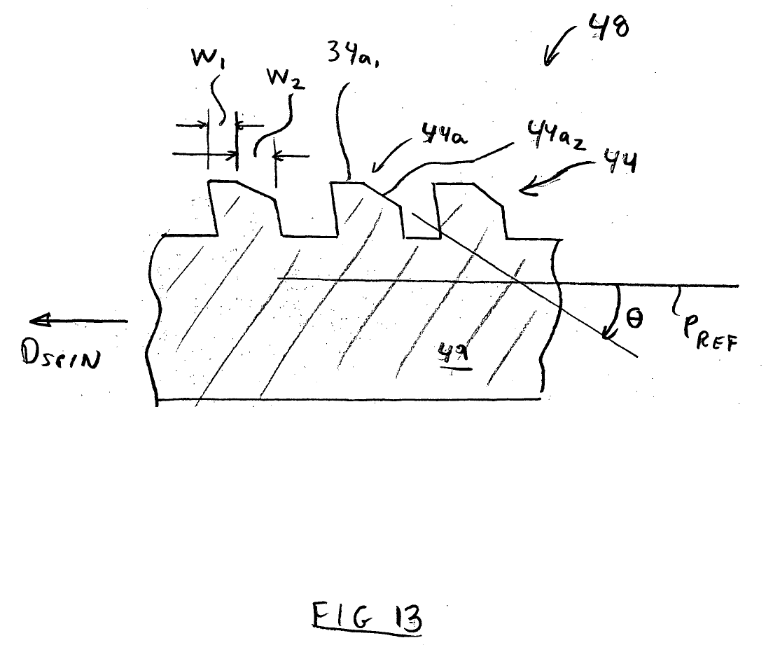

FIGS. 12 and 13 show two illustrative alternative embodiments of bars according to the present invention that employ jointed top surfaces. FIG. 12 shows a jointed top surface 34a for a bar 34 projecting from a body portion 39 of a refiner plate 38. The top surface 34a has two planer portions 34a₁ and 34a₂. The portion 34a₁ is leading or upstream with respect to the direction of rotation D_{SPIN}, relative to the portion 34a₂, which is trailing or downstream. The upstream portion 34a₁ is provided with a non-zero relief angle θ and the downstream portion 34a₂ is provided with a zero relief angle. The relief angle of the upstream portion 34a₁ can be substantially greater than that described above and still provide for the essentially the same overall elevation of the bar. This configuration maximizes the cutting action while minimizing the effect on the grooves and dams.

The relief angle can be made larger than in the bars 24 as a consequence of adjusting widths “W” of the portions, namely an upstream width W₁ and downstream width W₂ of the upstream and downstream portions 34a₁ and 34a₂, as will be readily appreciated by persons of ordinary mechanical skill.

FIG. 13 shows another jointed top surface 44a for a bar 44 projecting from a body portion 49 of a refiner plate 48. The bar 44 has an upstream portion 44a, and a downstream portion 44a₂. In this case, which is inverse to that described immediately above, the downstream portion 44a₂ is provided with a non-zero relief angle and the upstream portion 44a₁ has a zero relief angle. This provides for some additional grinding and less cutting; however, it may be desirable to maximize the life of the refiner plate. That is, the refiner plate may be renewed by the process known as “jointing” by grinding or facing the upstream portion 44a₁. Widths W of the portions, namely an upstream width W₁ and downstream width W₂ of the upstream and downstream portions 44a₁ and 44a₂ respectively, may be adjusted to provide a desired trade-off.

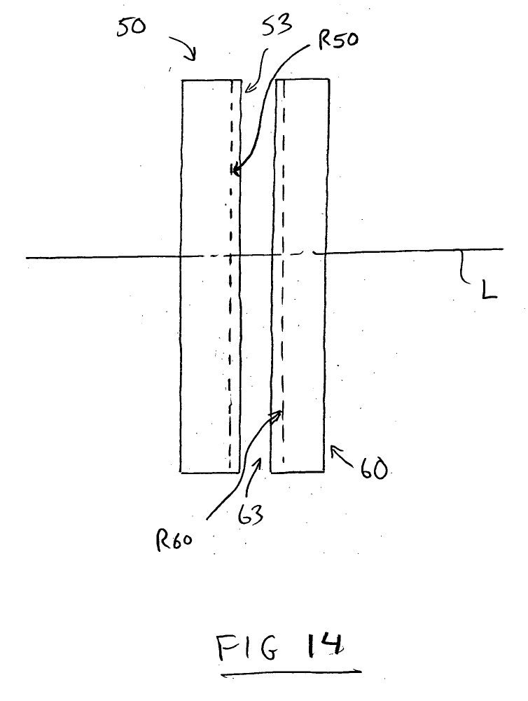

A refiner plate having bars defining a particular relief angle, or in the case of the jointed surface embodiments a particular combination of relief angles, may be and according to the invention often are preferably paired with an opposed refiner plate having bars defining a different relief angle or set of relief angles, as next illustrated in connection with FIGS. 14-16.

FIG. 14 shows a generic pair of opposed refiner plates in side elevation. One of the plates 50 has a “grinding face” 53 with bars (not shown) all having a “relief” referenced as “R₅₀,” i.e., a relief angle that defines the hidden line shown. The other plate 60 has a “grinding face” 63 that similarly has a relief “R₆₀.” Tests have indicated that it is preferable to provide that the relief R₅₀ is not equal to the relief R₆₀. For example, the relief R₅₀ may be 6° while the relief R₆₀ may be zero. Testing of this particular combination shows a very significant reduction in power consumption; on the other hand, the quality of the particles produced is not optimum in that there is a tendency to produce particles that are over-size. This trade off will be advantageous, however, where power consumption considerations are paramount and particle quality of is of lesser concern, such as in pre-processing or pre-refining operations.

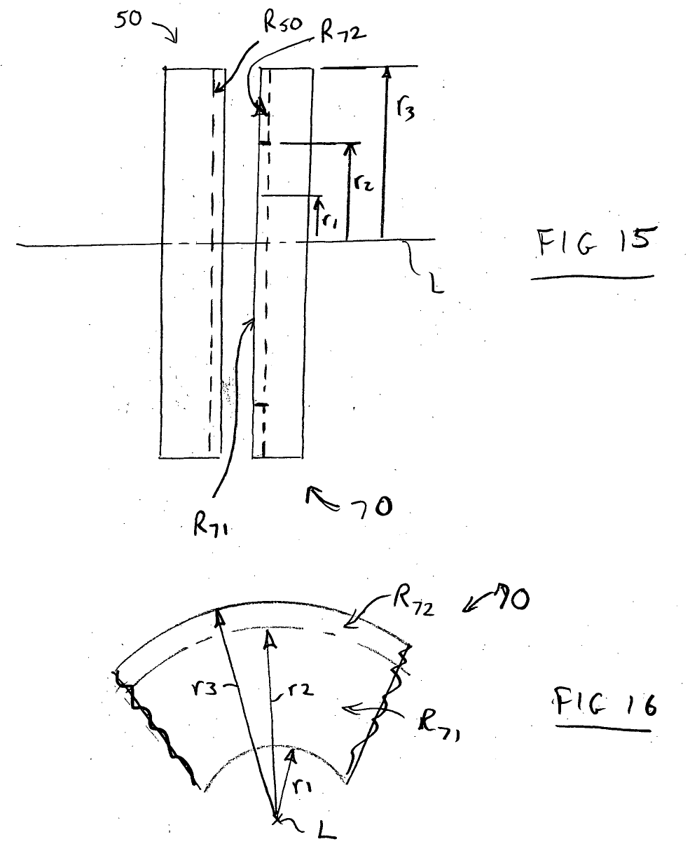

FIG. 15 shows the refiner plate 50 of FIG. 14 paired with an alternative refiner plate 70 according to the invention. The refiner plate 70 has bars (not shown) having top surfaces comprising multiple planar segments at varying elevations. More particularly, the plate 70 in this example provides a set of two reliefs R₇₁ and R₇₂ that increase with radial distance r from the axis of rotation L. Referring in addition to FIG. 16 showing schematically a sector of the refiner plate 70 in plan, the relief R₇₁is applied to a radially innermost portion of the plate 70 defined between radial distances “r1” and “r2” referenced from the axis of rotation L. The relief R₇₂ is then applied to the remaining (in this case), radially outermost portion of the plate between the radial distances r2 and “r3.” A single bar may extend over both the innermost and outermost portions and therefore have two reliefs, or separated bars aligned but spaced apart in the radial direction such as shown in FIG. 8 can be provided; where such bars are disposed within the innermost region they may have one relief R₇₁, and where such bars are disposed within the outermost region they may have the other relief R₇₂.

Test results for the two refiner plates 50 and 70, where the relief R₅₀ is 6° while the reliefs R₇₁ and R₇₂ are zero and 6°, respectively, show both high quality particles and a power reduction of 10-15% over the prior art.

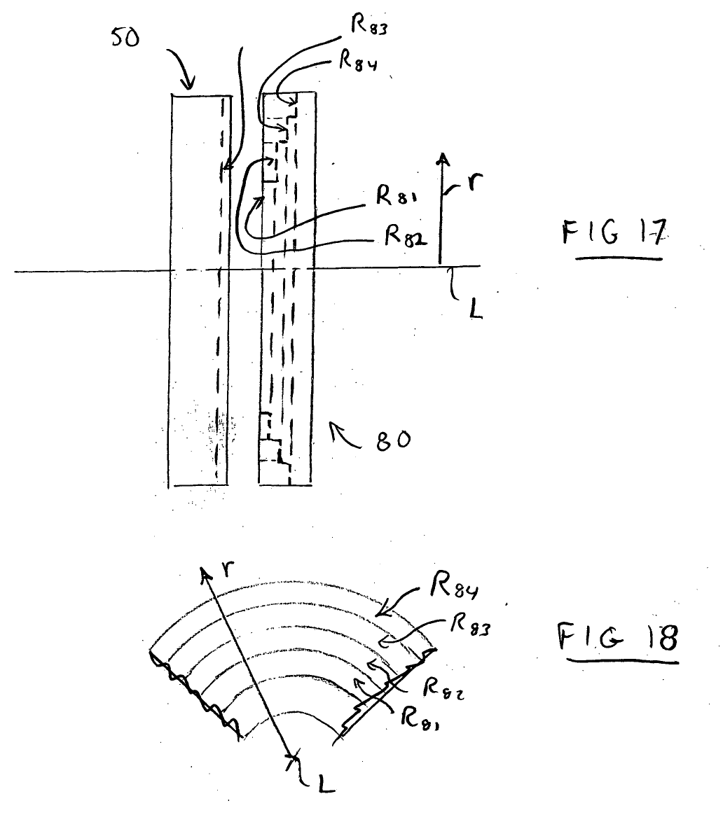

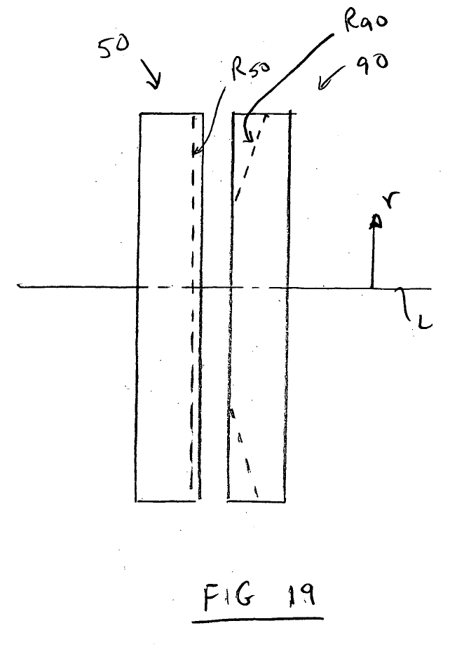

FIGS. 17-18 illustrate another refiner plate 80 having bars (not shown) with top surfaces comprising multiple planar segments at varying elevations. Particularly, the plate 80 provides for four different reliefs R₈₁, R₈₂, R₈₃, and R₈₄ that increase with radial distance r from the axis of rotation L. For example, the reliefs R₈₁₋₈₄ can be zero degrees, 2°, 4°, and 6°, progressing from relatively radially inner portions to relatively radially outer portions of the refiner plate.

FIG. 19 shows yet another alternative refiner plate 90 defining a relief R₉₀ that is actually a continuum of relief angles that continuously vary with distance r, preferably increasing with radial distance as shown. The top surfaces of the bars in this example will be helical rather than planar. And helical top surfaces may be combined with planar top surfaces such as shown in FIG. 16 in any combination.

Such a manner of providing for relief may be combined with the manner shown in the embodiment of FIG. 16.

It is to be understood that, while a specific refiner plate has been shown and described as preferred, other configurations and methods could be utilized, in addition to those already mentioned, without departing from the principles of the invention. The terms “refiner plate,” “disc refiner” and “bar” are terms art and are therefore intended to have the specific meanings ordinarily attributed to them by persons of ordinary skill.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims which follow.

1. A refiner plate defining an axis of rotation that further defines variations in azimuth, the refiner plate comprising:
an annular body portion; and
a plurality of azimuthally spaced-apart, elongate bars extending in generally radial directions and projecting from said body portion, said bars having top surfaces, each top surface having an elevation that varies, with respect to a reference plane perpendicular to the axis of rotation, as a function of azimuth to provide for relief, thereby adapting the refiner plate for increased cutting action and decreased grinding action.

2. The refiner plate of claim 1, wherein each said top surface defines a single plane that is angled with respect to said reference plane by a relief angle θ in the range 1-30 degrees.

3. The refiner plate of claim 2, wherein each said top surface defines two planes, one of which has a zero relief angle θ₁ and the other of which has a non-zero relief angle θ₂.

4. The refiner plate of claim 3, wherein said relief angle θ₂ is in the range 1-30 degrees.

5. The refiner plate of claim 1, wherein each said bar includes a planar side intersecting the respective said top surface that defines an attack angle α in the range 45 to 90 degrees measured with respect to said reference plane.

6. The refiner plate of claim 5, wherein each said top surface defines a single plane that is angled with respect to said reference plane by a relief angle θ in the range 1-30 degrees.

7. The refiner plate of claim 5, wherein each said top surface defines two planes, one of which has a zero relief angle θ₁ and the other of which has a non-zero relief angle θ₂.

8. The refiner plate of claim 7, wherein said relief angle θ₂ is in the range 1-30 degrees.

9. The refiner plate of claim 5, wherein said top surfaces of said bars define a “grinding face” of the refiner plate providing for at least two different relief angles, a first one of said relief angles defining relief for a relatively radially inner portion of the refiner plate and a second one of said relief angles defining relief for a relatively radially outer portion of the refiner plate.

10. The refiner plate of claim 9, wherein said first relief angle is less than said second relief angle.

11. The refiner plate of claim 1, wherein said top surfaces of said bars define a “grinding face” of the refiner plate providing for at least two different relief angles, a first one of said relief angles defining relief for a relatively radially inner portion of the refiner plate and a second one of said relief angles defining relief for a relatively radially outer portion of the refiner plate.

12. The refiner plate of claim 11, wherein said first relief angle is less than said second relief angle.

13. A disc refiner, comprising a refiner plate defining an axis of rotation that further defines azimuthal directions, the disc refiner further defining a direction of rotation of said refiner plate, the refiner plate including:
an annular body portion; and
a plurality of azimuthally spaced-apart, elongate bars projecting from said body portion, said bars having respective top surfaces, each top surface having an elevation, with respect to a reference plane perpendicular to the axis of rotation, that, at least in part, decreases as a function of azimuth in a direction opposite to the direction of rotation to provide for relief, thereby adapting the refiner plate to provide increased cutting action and decreased grinding action.

14. The disc refiner of claim 13, wherein each said top surface defines a single plane that is angled with respect to said reference plane by a relief angle θ in the range 1-30 degrees.

15. The disc refiner of claim 13, wherein each said top surface defines two planes, one of which has a zero relief angle θ₁ and the other of which has a non-zero relief angle θ₂.

16. The disc refiner of claim 15, wherein said relief angle θ₂ is in the range 1-30 degrees.

17. The disc refiner of claim 13, wherein each said bar includes a side intersecting said top surface that leans forwardly in said direction of rotation, to provide for attack, and thereby adapting the refiner plate for further increased cutting action.

18. The disc refiner of claim 17, wherein each said side is planar and each said top surface defines a single plane that is angled with respect to said reference plane by a relief angle θ in the range 1-30 degrees.

19. The disc refiner of claim 17, wherein each said side is planar and each said top surface defines two planes, one of which has a zero relief angle θ₁, and the other of which has a non-zero relief angle θ₂.

20. The disc refiner of claim 19, wherein said relief angle θ₂ is in the range 1-30 degrees.

21. The refiner plate of claim 17, wherein said top surfaces of said bars define a “grinding face” of the refiner plate providing for at least two different relief angles, a first one of said relief angles defining relief for a radially innermost portion of the refiner plate and a second one of said relief angles defining relief for a radially outermost portion of the refiner plate.

22. The refiner plate of claim 21, wherein said first relief angle is less than said second relief angle.

23. The refiner plate of claim 13, wherein said top surfaces of said bars define a “grinding face” of the refiner plate providing for at least two different relief angles, a first one of said relief angles defining relief for a relatively radially inner portion of the refiner plate and a second one of said relief angles defining relief for a relatively radially outer portion of the refiner plate.

24. The refiner plate of claim 23, wherein said first relief angle is less than said second relief angle.
